(19) United States
(12) Patent Application Publication
(10) Pub. No.: US 2017/0075070 A1
(43) Pub. Date: Mar. 16, 2017

(54) OPTICAL COUPLER FOR COUPLING LIGHT IN/OUT OF AN OPTICAL RECEIVING/EMITTING STRUCTURE

(71) Applicant: CCS Technology, Inc., Wilmington, DE (US)

(72) Inventors: Chenueh Abongwa Florian Lohse, Berlin (DE); Vladimir Nikolaevich Nazarov, St. Petersburg (RU)

(21) Appl. No.: 15/259,336

(22) Filed: Sep. 8, 2016

Related U.S. Application Data
(60) Provisional application No. 62/217,208, filed on Sep. 11, 2015.

(51) Int. Cl. G02B 6/30; G02B 6/36; G02B 6/32

(52) U.S. Cl. CPC G02B 6/30; G02B 6/32; G02B 6/3652

(57) ABSTRACT

An optical coupler (1) for coupling light in/out of an optical receiving/emitting structure comprises an optical fiber (100), a supporting device (200) to support the optical fiber (100) comprising a supporting structure (210) in which the optical fiber is arranged, and a covering device (300) to cover the supporting structure. An end face (E100a) of the optical fiber (100) is configured to reflect the light to one of the supporting device (200) and the covering device (300) comprising a first area and a second area (210, 220, 310, 320) being provided with a respective different index of refraction or a change of the respective index of refraction so that the first area (310) is configured as one of an optical waveguide (311) and at least one optical lens (312) being embedded in the second area and forming an optical pathway in said one of the supporting device and the covering device.

### CROSS-REFERENCE TO RELATED APPLICATIONS

This application claims the benefit of priority to U.S. Provisional Application No. 62/217,208, filed on Sep. 11, 2015, and is incorporated herein by reference.

### FIELD

An optical coupler to couple light in/out of an optical receiving/emitting structure which may be arranged on a substrate, for example a Photonic integrated circuits (PIC) chip is disclosed. Also disclosed are methods for manufacturing an optical coupler to couple light in/out of an optical receiving/emitting structure.

### BACKGROUND

Photonic integrated circuits (PIC) may be manufactured by Silicon Photonics (SiP), Indium Phosphide (InP) or other technologies. These technologies still suffer from the need for high effort for fiber-to-chip coupling in relation to time and cost and/or high optical losses. There are two main approaches that are used for fiber-to-chip coupling. The first approach is based on edge coupling where the optical fiber is coupled in-plane of the chip surface at an edge of the chip. An adiabatic taper which may be made from polymer materials is lithographically processed on the chip and transfers the relatively small optical mode of a waveguide on a chip with dimensions as small as 200 nm×400 nm to the size of the mode of a standard single-mode fiber (SMF) used in the telecommunication and data communication market which has a mode diameter of approx. 9.2 μm at a wavelength of 1310 nm.

The second approach uses a grating coupler (GC) for coupling the optical signal vertically out of the PIC. The grating is created by introducing a periodic modulation of the refractive index along the waveguide path which causes the light to be emitted out of the plane of the chip surface. Simple horizontal tapering of the waveguides and adapting the length of the modulated index region allows matching of the emitting optical mode to that one of the single-mode fiber.

For optical modules, in-plane coupling is one of the typical approaches because packaging is easier and optical modules are constrained in package height in most applications. Other commercial products with grating couplers use fiber v-groove arrays that are directly vertically attached to the chip where the fiber gets bent afterwards to a horizontal position, which requires packages that have larger sizes such as packages with larger heights. The additional area consumption needs to be preserved. Common methods of implementing optical turns are based on injection molded parts containing total internal reflection (TIR) mirrors and micro lenses. That works for multimode based systems where relatively loose tolerances compared to single mode systems can be allowed. Finally angle-cleaved or polished fibers with a TIR surface at the end of the fibers are also used to reflect the optical signal by 90° to 100° matching the individual grating coupler design. When using such fibers in a v-groove array, a covering device/lid has to be used to cover and fix the optical fibers arranged in the grooves of the v-groove array. The covering device will introduce excess coupling losses due to the fact that the light is not guided anymore and diverges in the covering device which may have a non-standard thickness to reduce the effect.

There is a desire to provide an optical coupler to couple light in/out of an optical receiving/emitting structure efficiently with low loss. There is also an unresolved need for providing methods to manufacture an optical coupler to couple light in/out of an optical receiving/emitting structure efficiently with low loss.

### SUMMARY

An optical coupler to couple light in/out of an optical receiving/emitting structure comprises at least one optical fiber and a supporting device to support the at least one optical fiber. The supporting device comprises a supporting structure in which the at least one optical fiber is arranged. The optical coupler further comprises a covering device to precisely align and fix the at least one optical fiber in the supporting structure, wherein the covering device has a first and an opposite second surface. The end face of the at least one optical fiber comprises a light-turning/reflective surface.

The light turning/reflective surface may be configured to reflect the light guided in the at least one optical fiber and to direct it towards the covering device. The reflected light enters the covering device at the first surface of the covering device and propagates through an optical pathway inside the covering device. The light gets coupled out of the optical coupler at the second surface of the covering device to be coupled into an optical receiving structure.

According to another embodiment, the optical coupler may be configured such that the light coupled into the optical coupler from an optical emitting structure at the second surface of the covering device propagates through the optical pathway of the covering device and is coupled out of the first surface of the covering device into the at least one optical fiber at the end face of the at least one optical fiber.

According to a further embodiment, the optical pathway is included in the supporting device. In this case, the light turning/reflective surface of the at least one optical fiber is configured to reflect the light propagating in the at least one optical fiber such that the light is directed towards the supporting device. The light enters the supporting device at the first surface of the supporting device. The light propagates through an optical pathway of the supporting device and is coupled out of the optical coupler at the second surface of the supporting device to be coupled into an optical receiving structure.

According to another embodiment, the optical coupler may be configured such that the light coupled into the optical coupler from an optical emitting structure at the second surface of the supporting device propagates through the optical pathway of the supporting device and is coupled out of the first surface of the supporting device into the at least one optical fiber at the end face of the at least one optical fiber.

One of the covering device and the supporting device comprises a second area surrounding a first area, wherein the first area and the second area are provided with a respective different index of refraction or a change of the respective index of refraction so that the first area is configured as one of an optical waveguide and an optical lens being embedded in the second area and forming the optical pathway in said one of the supporting device and the covering device.

The optical pathway is defined from the reflective surface of the optical fiber to a portion of the device for coupling the optical signal to/from an optical receiving/emitting structure. The optical pathway may be formed by any suitable method such as laser writing or ion exchange. Further, the methods of forming the optical pathway may allow the optical pathway to comprise one or more lenses or focusing areas for manipulating the optical signal for improved coupling. Depending on the method used for creating the optical pathway lenses may be formed at different locations along the optical pathway. For instance, laser writing allows the creation of one lens or more lenses at any point along the optical pathway, whereas ion exchange creates one lens or more lenses below the surface of a component such as one covering device or a stack of multiple covering devices or a supporting device. The concepts disclosed herein may be used with any suitable types of optical fibers and additionally may be used with an array of optical fibers as desired.

The end face of the optical fiber may be prepared by machining/polishing a TIR mirror surface to the end face of the optical fiber to realize an optical turn at the end face of the optical fiber. However, other structures are possible for turning/reflecting the light signal at the end face of the optical fiber such as providing a metalized surface or using any reflective single or multi-layer dielectric coating or diffractive elements attached on the end face of the optical fiber that acts as a mirror for turning/reflecting the light. The light that is guided in the optical fiber is coupled out at the mirror surface of the optical fiber and is deflected towards the covering device or supporting device.

Instead of using a passive covering device, the optical coupler comprises a covering device for covering the supporting structure, for example a v-groove array, wherein the covering device contains either embedded waveguides or optical lenses or combinations thereof. An embedded waveguide or optical lens may be arranged in a path perpendicular to a fiber axis of the optical fiber arranged in the supporting structure. The light coupled out at the end face of the optical fiber is either guided by the waveguide or imaged by the optical lens between the fiber facet and the optical receiving/emitting structure disposed on a substrate, for example a chip surface where a grating coupler is located. Grating couplers facilitate nearly vertical emission/injection from/to a chip as well as good mode matching to single mode fiber.

The additional optical features, such as either waveguides or optical lenses, which are introduced in the material of the covering device overcome the practical limitation of the finite thickness of the covering device and allow to increase coupling efficiency, because the light is guided in the waveguide through the covering device or focused by the optical lens so that any divergence of the light may be avoided in most instances.

According to another embodiment of the optical coupler, at least one optical element, such as an optical waveguide or at least one optical lens or combinations thereof, can be provided in the supporting device, for example a v-groove substrate. In this case, the end face of the at least one optical fiber may be prepared to reflect the light coupled out of the core of the at least one optical fiber through the at least one optical element of the supporting device towards an optical receiving structure, for example a grating coupler. Light may also be coupled out of an optical emitting structure towards the supporting device. The light is transferred through the at least one optical element of the supporting device and reflected at the end face of the at least one optical fiber to be coupled in the core section of the at least one optical fiber.

A first embodiment of a method to manufacture an optical coupler to couple light in/out of an optical receiving/emitting structure with low loss comprises a step of providing a supporting device comprising a supporting structure, and a step of providing a covering device having a first and an opposite second surface. At least one optical fiber is arranged in the supporting structure. A covering device is placed on the supporting structure such that the supporting structure is covered by the first surface of the covering device and the at least one optical fiber is fixed between the supporting structure and the covering device.

An end face of the at least one optical fiber is prepared such that the light guided in the at least one optical fiber is reflected at the end of the at least one optical fiber to be coupled out of the at least one optical fiber and coupled in one of the covering device and the supporting device at the first surface of said one of the covering device and the supporting device and to propagate through an optical pathway of said one the covering device and the supporting device and coupled out of the optical coupler at the second surface of said one of the covering device and the supporting device to be coupled into the optical receiving structure and/or the light coupled into the optical coupler from the optical emitting structure at the second surface of said one of the covering device and the supporting device propagates through the optical pathway of said one of the covering device and the supporting device and is coupled out of the first surface of said one of the covering device and the supporting device into the at least one optical fiber at the end face of the at least one optical fiber.

The one of the covering device and the supporting device is prepared by means of a laser writing process such that said one of the covering device and the supporting device is provided with a second area surrounding a first area, wherein the first area and the second area are provided with a respective different index of refraction or a change of the respective index of refraction so that the first area is configured as one of an optical waveguide and at least one optical lens being embedded in the second area and forming the optical pathway in said one of the supporting device and the covering device.

It is to be understood that the manufacturing method does not necessarily produce a sharp demarcation between the first area and the second area; instead, the change in the index of refraction will be relatively smooth. Further, the laser writing does not need to be limited to the covering device or supporting device, but may be extended into the cladding of the optical fiber(s) as desired.

According to a second embodiment of a method to manufacture an optical coupler to couple light in/out of an optical receiving/emitting structure, the method comprises a step of providing a supporting device comprising a supporting structure, and a step of providing a covering device having a first and an opposite second surface. One of the covering device and the supporting device is prepared by means of a ion exchange process such that said one of the covering device and the supporting device is provided with a second area surrounding the first area, wherein the first area and the second area are provided with a respective different index of refraction or a change of the respective index of refraction so that the first area is configured as an optical lens being embedded in the second area and forming an optical pathway in said one of the covering device and the supporting device. At least one optical fiber is arranged in the supporting structure. The covering device is placed on the supporting structure such that the supporting structure is covered by the first surface of the covering device and the at least one optical fiber is fixed between the supporting structure and the covering device.

An end face of the at least one optical fiber is prepared such that the light guided in the at least one optical fiber is reflected from the end face of the at least one optical fiber to be coupled out of the at least one optical fiber and coupled in said one of the covering device and the supporting device at the first surface of the covering device and to propagates through the optical pathway of said one of the covering device and the supporting device and coupled out of the optical coupler at the second surface of said one of the covering device and the supporting device to be coupled into the optical receiving structure and/or the light coupled into the optical coupler from the optical emitting structure at the second surface of said one of the covering device and the supporting device propagates through the optical pathway of said one of the covering device and the supporting device and is coupled out of the first surface of said one of the covering device and the supporting device into the at least one optical fiber at the end face of the at least one optical fiber.

### BRIEF DESCRIPTION OF THE DRAWINGS

FIG. 1 shows an embodiment of an optical coupler for coupling an optical fiber array to an optical receiving/emitting structure with non-standard covering device thickness.

FIG. 2 shows an appropriate position of a cleave in a supporting and covering device to form a mirror surface at an end face of an optical fiber.

FIG. 3 shows a diagram illustrating a coupling efficiency versus a distance from optical receiving/emitting structure to fiber core without using embedded optical elements.

FIGS. 4A and 4B respectively show an embodiment of an optical coupler from different views to couple light in/out of an optical receiving/emitting structure using an optical waveguide.

FIG. 5 shows another embodiment of an optical coupler to couple light in/out of an optical receiving/emitting structure using one or multiple lenses.

FIG. 6A shows another embodiment of an optical coupler to couple light in/out of an optical receiving/emitting structure comprising a single optical lens in a first portion of the covering device.

FIG. 6B shows another embodiment of an optical coupler to couple light in/out of an optical receiving/emitting structure comprising a respective optical lens in each portion of the covering device.

FIG. 7 shows another embodiment of an optical coupler to couple light in/out of an optical receiving/emitting structure using a cavity filled with adhesive in at least one of the first and second portion of the covering device.

FIG. 8 illustrates an embodiment of a method to manufacture an optical coupler to couple light in/out of an optical receiving/emitting structure using a laser writing process.

FIG. 9 shows a ion exchange process as part of another embodiment of a method to manufacture an optical coupler to couple light in/out of an optical receiving/emitting structure using an ion exchange process.

FIG. 10A shows a top view of an optical lens array embedded in a covering device of an optical coupler including alignment marker.

FIG. 10B shows a top view of a panel with a plurality of optical lens arrays of optical couplers.

FIG. 11 shows an alignment of two panels respectively including different portions of a covering device of an optical coupler.

FIG. 12 shows a processing step of placing a covering sub-assembly to a supporting device of an optical coupler.

FIG. 13 shows the appropriate position of a cleave to form the mirror surface at an end face of an optical fiber with respect to the embedded lens element for a 90° reflection.

FIG. 14 shows a top view to an embodiment of an optical coupler comprising a substrate with a plurality of v-grooves to support optical fibers and a covering device comprising lens elements and alignment marks.

FIGS. 15A and 15B respectively show diagrams illustrating a coupling efficiency versus displacement tolerances without and with compensation of an inaccurate mirror position.

FIG. 16A shows an embodiment of an optical coupler to couple light in/out of an optical receiving/emitting structure comprising a single optical lens in a first portion of the supporting device.

FIG. 16B shows another embodiment of an optical coupler to couple light in/out of an optical receiving/emitting structure comprising a single optical lens in a second portion of the supporting device.

FIG. 17 shows an embodiment of a method to manufacture an optical coupler to couple light in/out of an optical receiving/emitting structure using an ion exchange process on the first portion of the supporting device.

FIG. 18 illustrates two possibilities to perform a ion exchange process to provide an optical lens in the material of the supporting device or the covering device of the optical coupler.

### DETAILED DESCRIPTION

The optical coupler and the method to manufacture the optical coupler will now be described in more detail hereinafter with reference to the accompanying drawings showing embodiments of the optical coupler and the method. The coupler and the method may, however, be embodied in many different forms and should not be construed as limited to the embodiments set forth herein; rather, these embodiments are provided so that the disclosure will fully convey the scope of the optical coupler and the manufacturing method to those skilled in the art. The drawings are not necessarily drawn to scale but are configured to clearly illustrate the embodiments of the optical coupler and the method to manufacture the optical coupler.

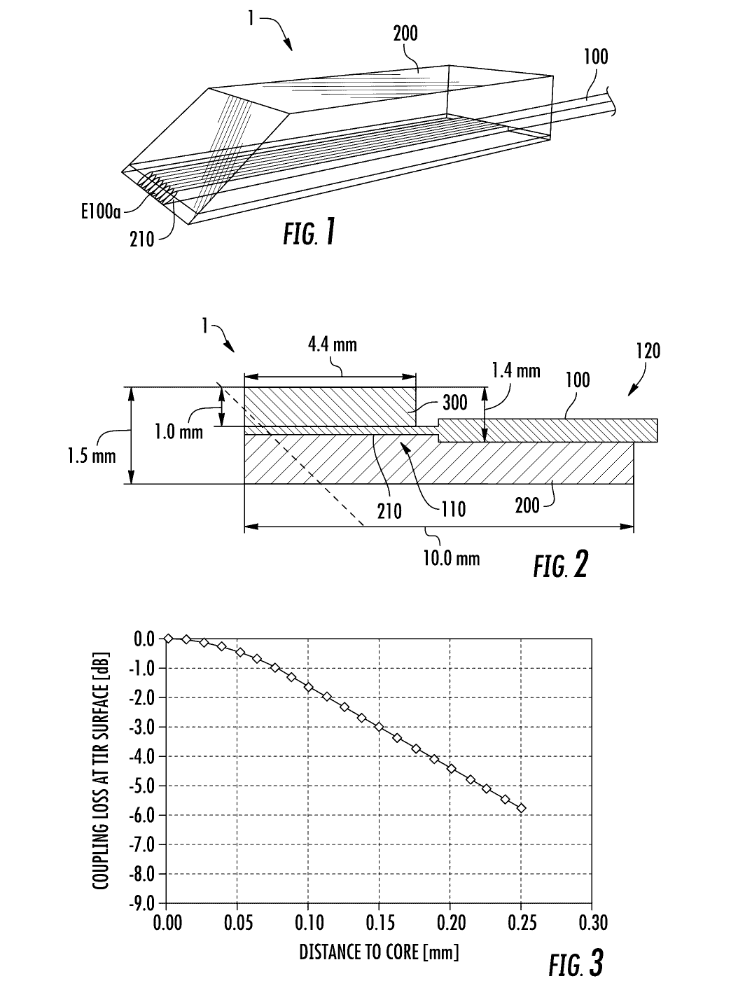

FIG. 1 shows an embodiment of optical coupler 1 comprising a supporting device 200 comprising a supporting structure 210 in which optical fibers 100 of a fiber array are disposed. The end faces E100a of the optical fibers are polished such that light guided through each of the optical fibers is reflected (e.g., coupled out) at the respective end face E100a of the optical fibers by means of total internal reflection (TIR) surface or other suitable reflection surface such as a mirror formed by a metal or dielectric single or multi-layer. The light is coupled out of a respective core of the optical fibers and goes through the respective cladding of the optical fibers before the light is coupled out of the optical coupler, for example in a direction towards an optical receiving structure arranged on an optical chip. The cladding leads to a divergence of the light rays leaving the optical fibers which causes optical losses when the light is transferred between the respective core of the optical fibers and the receiving structure.

FIG. 2 shows an appropriate position of a cleave in a supporting device 200 and covering device 300 to form a mirror surface at an end face of an optical fiber. The optical fibers 100 comprise a bare glass portion 110 and a coated portion 120. The supporting structure is covered by a covering device 300 to fix the optical fibers, for example, in grooves of the supporting structure to maintain required tolerances. The indicated dimensions illustrate a possible embodiment of the optical coupler and are not to be understood as limiting the embodiment to the indicated size. The dashed line shows a cut through the material of the supporting device and the covering device after polishing to provide total internal reflection at the end face of an optical fiber disposed in the supporting structure.

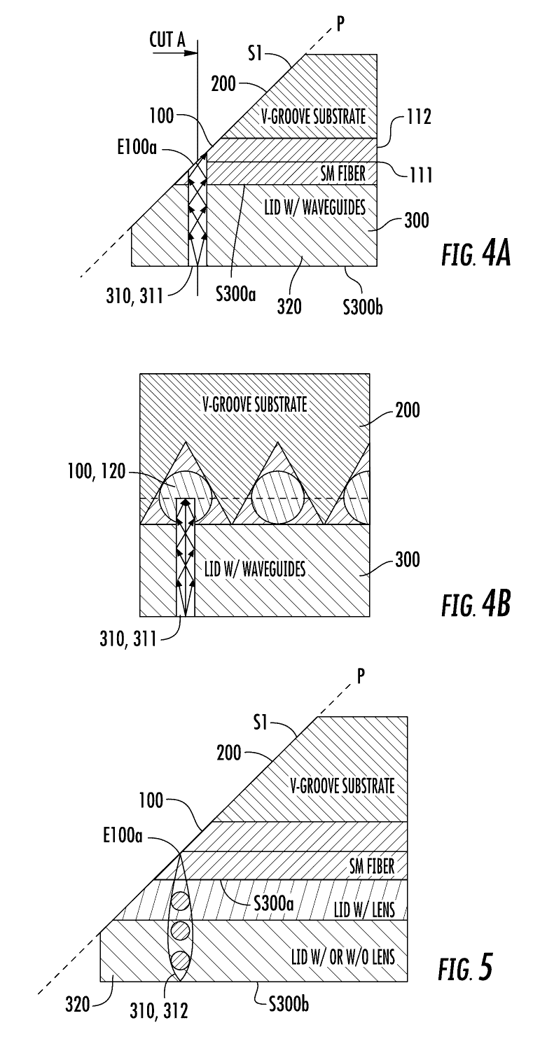

Referring to FIG. 2, light coupled out of an optical core at the end face of an optical fiber at the polished surface of the optical coupler is guided through the cladding of the optical fiber and through the covering device 300 before leaving the optical coupler towards an optical receiving structure which may be arranged on a surface of an optical chip. The reflected light diverges while propagating through the cladding and the material of the covering device which leads to an increasing beam diameter and thus an optical loss when the light is coupled to an optical receiving structure on the chip. FIG. 3 shows the dependency of coupling loss versus distance from optical receiving/emitting structure to fiber core including thickness of the covering device 300. Assuming this distance to be 150 μm introduces a loss of about 3 dB.

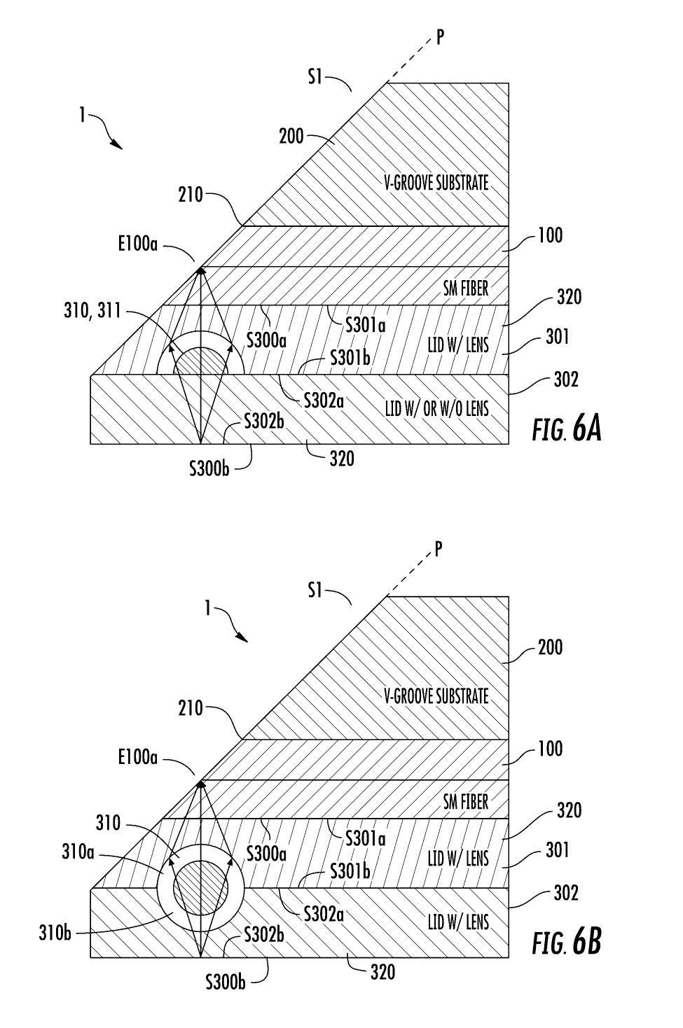

FIGS. 4A and 4B, 5, 6A, 6B and 7 show different embodiments of an optical coupler 1 to couple light in/out of an optical receiving/emitting structure having reduced/low loss when light is transferred between a core 111 of at least one optical fiber and the optical receiving/emitting structure. The optical receiving/emitting structure is not shown in FIGS. 4A, 4B, 5, 6A, 6B and 7.

According to all of the embodiments of the optical coupler, the optical coupler 1 comprises at least one optical fiber 100 and a supporting device 200 to support the at least one optical fiber. The supporting device 200 comprises a supporting structure 210 in which the at least one optical fiber 100 is arranged. The supporting structure 210 may be configured as at least one groove in the material of the supporting device 200. The at least one groove may have any suitable shape for accurately positioning the at least one optical fiber in the optical coupler. By way of example, the grooves may be V-grooves, U-grooves, square-grooves or the like.

The optical coupler further comprises a covering device 300 to cover the supporting structure 210. The covering device 300 has a first surface S300a and an opposite second surface S300b. The covering device 300 may be attached to the supporting structure 210 and the at least one optical fiber 100 being arranged in the supporting structure 210 by means of an adhesive being disposed between the first surface S300a of the covering device 300 and the supporting structure 210/the at least one optical fiber 100.

An end face E100a of the at least one optical fiber 100 is configured to couple the light in/out of the at least one optical fiber 100. To this purpose, the end face E100a of the at least one optical fiber may be polished to provide the end of the at least one optical fiber with an inclined end face E100a to allow total internal reflection of light guided in the optical fiber at the slanted end face E100a. According to another possible embodiment, the end face of the at least one optical fiber is metalized, provided with a reflective single or multi-layer dielectric coating to reflect the light or provided with a diffractive element/coating.

The end face E100a of the at least one optical fiber 100 comprises a light-turning/reflective surface being configured to reflect light such that the light propagating in the at least one optical fiber 100 is reflected at the end face of the at least one optical fiber to be coupled out of the at least one optical fiber 100 and coupled in the covering device 300 at the first surface S300a of the covering device. The light propagates through an optical pathway of the covering device and is coupled out of the optical coupler 1 at the second surface S300b of the covering device 300 to be coupled into the optical receiving structure 300 and/or the light coupled into the optical coupler 1 from the optical emitting structure at the second surface S300b of the covering device 300 propagates through the optical pathway of the covering device 300 and is coupled out of the first surface S300a of the covering device into the at least one optical fiber 100 at the end face E100a of the at least one optical fiber.

The covering device 300 comprises a first area 310 and a second area 320 surrounding the first area. The first area 310 and the second area 320 are provided with a respective different index of refraction or a change of the respective index of refraction so that the first area 310 is configured as one of an optical waveguide and an optical lens being embedded in the second area 320 and forming the optical pathway in the covering device. The first area 310 may extend from the fiber core 111 of the at least one optical fiber 100 through the cladding 112 of the at least one optical fiber and the covering device 300 to the second surface S300b of the covering device 300.

According to all of the embodiments of the optical coupler 1 shown in FIGS. 4A and 4B, 5, 6A, 6B and 7, the at least one optical fiber 100 is arranged in the supporting structure 210 of the supporting device 200 such that the end face E100a of the at least one optical fiber ends in a plane P of a lateral surface S1 of the optical coupler 1. The lateral surface S1 of the optical coupler 1 is cut such that the plane P of the lateral surface S1 is inclined in relation to a longitudinal direction of the portion of the at least one optical fiber 100 arranged in the supporting structure 210 by an angle being larger than the angle at which total internal reflection (TIR) of the light guided in the optical fiber occurs at the end face E100a of the at least one optical fiber. The reflection at the end face of the at least one optical fiber can rely on internal reflection solely or can be metalized, provided with a reflective single or multi-layer dielectric coating or a diffractive element attached to it to reflect the light.

According to all of the embodiments of the optical coupler 1 shown in FIGS. 4A and 4B, 5A, 5B, 6 and 7, the second area 320 of the covering device 300 surrounds the first area 310 of the covering device. The first area 310 and the second area 320 of the covering device 300 have a different index of refraction. According to another embodiment of the optical coupler the second area 320 of the covering device 300 is provided with a second index of refraction. The first area 310 of the covering device 300 is provided with a transition of the index of refraction from a first index of refraction to the second index of refraction in the direction towards the second area 320.

FIGS. 4A and 4B show an embodiment of the optical coupler in two different cuts. According to the embodiment of the optical coupler 1 shown in FIGS. 4A and 4B, the first area 310 of the covering device 300 is formed as a light-guiding structure 311, for example as a waveguide, to guide the light inside the covering device 300. The waveguide may be configured as a single-mode or multi-mode waveguide. The light-guiding structure/waveguide 310 is arranged between the fiber core 111 of the at least one optical fiber 100 and the second surface S300b of the covering device. The light-guiding structure may be disposed in the cladding region 112 of the optical fiber(s) and in the covering device 300.

Light coupled out at the polished fiber end face E100a of the at least one optical fiber is guided essentially within the light-guiding structure/waveguide 310 and is inhibited from entering the second area 320 of the covering device surrounding the first area 310. The first area 310 is configured as the core of the waveguide and the second area 320 may be configured as the cladding of the waveguide. The main portion of the light is guided in the core section of the waveguide. A small amount of the light may be transmitted in the cladding 320 of the waveguide. The first area 310 may also have a gradient index profile with a smooth transition to second area 320 so that sharply defined boundaries between areas 310, 320 may not exist.

According to the embodiments of the optical coupler 1 shown in FIGS. 5, 6A and 6B, the first area 310 of the covering device 300 is configured as at least one optical lens 312. The at least one optical lens 312 is configured to receive the light rays coupled out from the fiber core 111 and to focus the light rays in the direction towards the second surface S300b of the covering device 300 and/or to receive the light rays of the light coupled into the covering device 300 at the second surface S300b of the covering device 300 and to focus the light rays in the direction towards the fiber core 111.

FIG. 5 shows an embodiment of the optical coupler, wherein the covering device 300 is formed as one part comprising a plurality of optical lenses 312. The plurality of optical lenses is arranged within the material of the covering device 300 behind each other between the first surface S300a and the second surface S300b. An optical signal coupled out at the end face E100a of the at least one optical fiber 100 is coupled into the optical structure 312 of the covering device 300 and focused to the second side S300b of the covering device 300. An optical signal may also be coupled out of an optical emitting structure and coupled into the covering device 300 at the second side S300b. In this case, the optical signal is focused by means of the plurality of optical lenses 312 of the first area 310 of the covering device 300 in the direction towards the fiber core 111, i.e. to the end face E100a of the at least one optical fiber 100, so that the light is reflected at the inclined surface of the end face E100a and coupled into the at least one optical fiber 100.

FIGS. 6A and 6B respectively show an embodiment of an optical coupler 1, wherein the covering device 300 comprises a first portion 301 and a second portion 302. The first portion 301 of the covering device 300 has a first side S301a comprising the first surface S300a of the covering device and a second side S301b. The second portion 302 of the covering device 300 has a first side S302a and a second side S302b comprising the second surface S300b of the covering device 300. The first portion 301 of the covering device is attached with the first side S301a to the supporting structure 210 of the supporting device and is attached with the second side S301b to the first side S302a of the second portion 302 of the covering device 300.

According to the embodiment of the optical coupler 1 shown in FIG. 6A, the first area 310 of the covering device 300 extends from the second side S301b of the first portion 301 of the covering device 300 into the material of the first portion 301 of the covering device. The first area 310 is configured as an optical lens 312 as described above.

FIG. 6B shows an embodiment of the optical coupler 1, wherein the first area 310 of the covering device 300 comprises a first section 310a and a second section 310b. The first section 310a of the first area 310 of the covering device extends from the second side S301b of the first portion 301 of the covering device into the material of the first portion 301 of the covering device. The second section 310b of the first area 310 of the covering device 300 extends from the first side S302a of the second portion 302 of the covering device into the material of the second portion 302 of the covering device 300. The first and second section 310a and 310b of the first area 310 of the covering device may be configured as an optical lens as described above.

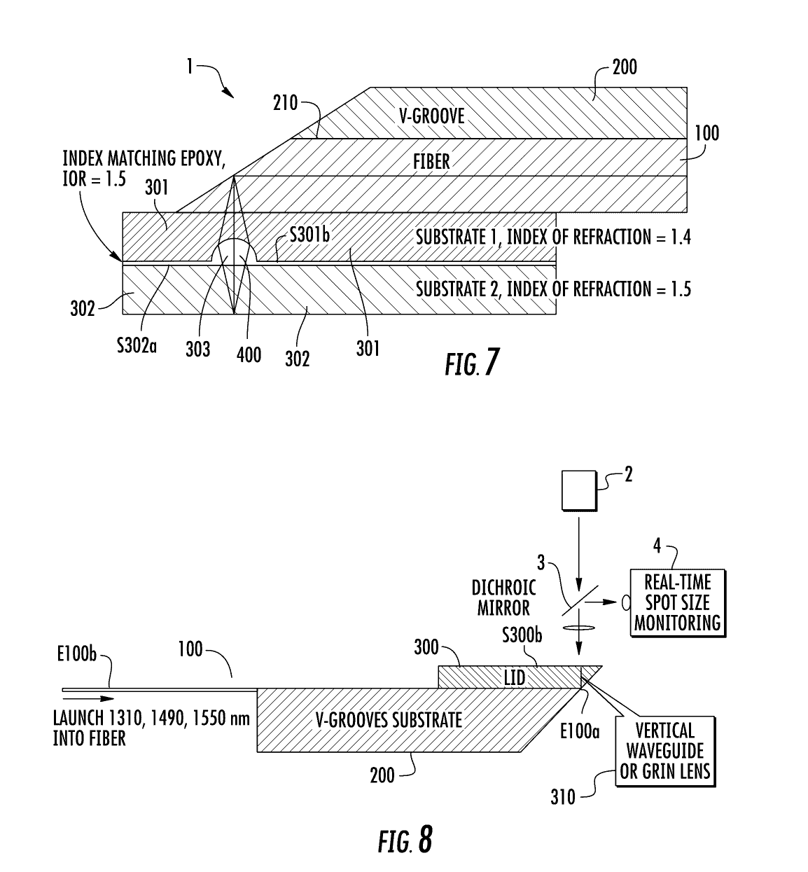

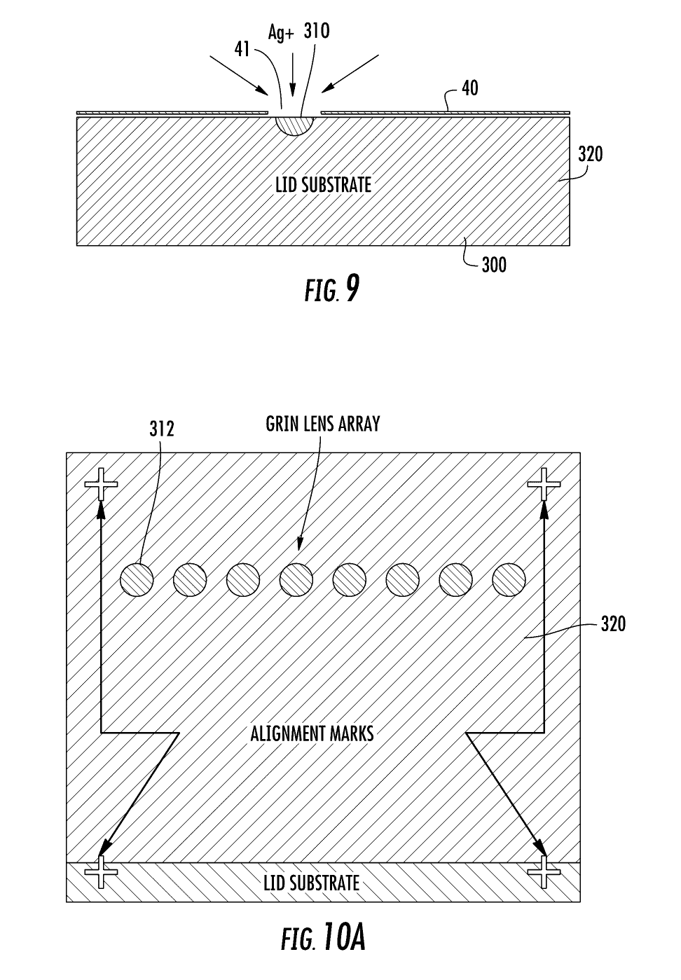

According to the embodiments of the optical coupler 1 shown in FIGS. 5, 6A and 6B, the first area 310 of the covering device may be configured as a GRIN (Gradient Index) lens. FIG. 7 shows an embodiment of an optical coupler 1, wherein the first portion 301 of the covering device 300 comprises a cavity 303 in the second side S301b of the first portion 301 of the covering device. The cavity 303 is filled with an adhesive 400. The adhesive 400 may have an index of refraction being different from the index of refraction of the material of the first portion 301 of the covering device. According to the exemplified embodiment of the optical coupler 1 illustrated in FIG. 7, the first portion 301 of the covering device has an index of refraction of 1.4, whereas the adhesive 400 and the second portion 302 of the covering device has an index of refraction of 1.5, but this is merely an example and variations are possible. The two portions 301, 302 of the covering device 300 can have the same refractive index which needs to be different from the index of refraction of the adhesive. The adhesive 400 may be configured as an index matching epoxy, but other embodiments may use a mismatched refractive index epoxy if the two portions of the covering device have the same index of refraction.

According to another embodiment of the optical coupler 1, the second portion 302 of the covering device 300 may comprise the cavity 303 in the first side S302a of the second portion 302 of the covering device. The cavity 303 may also be filled with the adhesive 400 having an index of refraction being different from the index of refraction of the material of the second portion 302 of the covering device.

According to a further embodiment of the optical coupler, the first and the second portion 301, 302 of the covering device may comprise a respective cavity. One of the cavities may be provided in the second side S301b of the first portion of the covering device and another one of the cavities may be provided in the first side S302a of the second portion of the covering device. The cavities are filled with adhesive having an index of refraction different to the first and second portion 301 and 302 of the covering device.

FIG. 8 illustrates a first embodiment of a method to manufacture an optical coupler 1 as shown in FIGS. 4A, 4B and 5 to couple light in/out of an optical receiving/emitting structure. In order to manufacture the optical coupler, the supporting device 200 comprising the supporting structure 210 is provided. Furthermore, the covering device 300 having the first surface S300a and the opposite second surface S300b is provided, wherein the covering device is made of a optically transparent material and still does not comprises the first and the second area 310, 320 of different index of refraction. An optical fiber 100 is arranged in the supporting structure 210. The covering device 300 being configured as one part is placed on the supporting structure 210 such that the supporting structure is covered by the first surface S300a of the covering device 300 and the optical fiber 100 is fixed between the supporting structure 210 and the covering device 300. For this purpose, the covering device 300 may be attached on the supporting structure 210 and the optical fiber 100 with adhesive.

The end face E100a of the optical fiber/the optical fiber array is prepared such that the light guided in the optical fiber 100 is reflected at the end face of the optical fiber to be coupled out of the optical fiber and coupled in the covering device 300 at the first surface S300a of the covering device and to propagate through an optical pathway of the covering device 300 and coupled out of the optical coupler at the second surface S300b of the covering device 300 to be coupled into an optical receiving structure and/or the light coupled into the optical coupler from an optical emitting structure at the second surface S300b of the covering device 300 propagates through the optical pathway of the covering device 300 and is coupled out of the first surface S300a of the covering device into the optical fiber 100 at the end face E100a of the optical fiber.

To this purpose, the lateral side surface S1 of the optical coupler 1 may be cut such that the plane P of the lateral surface S1 is inclined in relation to the longitudinal direction of the portion of the optical fiber 100 arranged in the supporting structure 210 by an angle larger than the angle at which total internal reflection of the light guided in the optical fiber occurs at the end face E100a of the optical fiber. Alternatively, the end face of the at least one optical fiber may be metalized, provided with a reflective single or multi-layer dielectric coating or a diffractive element attached to it to reflect the light

According to the embodiment of the method to manufacture the optical coupler 1 illustrated in FIG. 8, the covering device 300 and/or the fiber cladding 112 is prepared by laser processing by means of a laser 2 such that the covering device 300 and/or the fiber cladding 112 is provided with the first area 310 and the second area 320 surrounding the first area 310, wherein the first area 310 and the second area 320 are provided with a respective different index of refraction or a change of the respective index of refraction so that the first area 310 is configured as one of an optical waveguide and an optical lens being embedded in the second area 320 and forming the optical pathway in the covering device. The first area 310 extends from the fiber core 111 of the optical fiber 100 through the cladding 112 of the optical fiber and the covering device 300 to the second surface S300b of the covering device 300.

The covering device 300 and/or the fiber cladding 112 may be prepared by the laser 2 such that the first area 310 has a different index of refraction than the second area 320 of the covering device 300 and/or the fiber cladding 112. According to another embodiment, the covering device 300 and/or the fiber cladding 112 may be prepared by the laser such that the second area 320 of the covering device 300 and/or the fiber cladding 112 is provided with a second index of refraction. The first area 310 of the covering device 300 and/or the fiber cladding 112 may be provided with a transition of the index of refraction from a first index of refraction to the second index of refraction in the direction towards the second area 320.

In order to manufacture the optical coupler 1 comprising the light-guiding structure/waveguide 310 as shown in FIGS. 4A and 4B, the light-guiding structure 310 is written by means of the radiation of the laser 2 between the fiber core of the at least one optical fiber 100 and the second surface S300b of the covering device 300.

In order to manufacture the embodiment of the optical coupler 1 shown in FIG. 5 the first area 310 of the covering device 300 is written by means of the laser processing to provide at least one optical lens 312 inside the covering device. The laser 2 writes the at least one optical lens 312 to be configured to receive the light rays of the light coupled in the covering device at the first surface S300a of the covering device and to focus the light rays in the direction towards the second surface S300b of the covering device and/or to receive the light rays of the light coupled in the covering device 300 at the second surface S300b of the covering device and to focus the light rays in the direction towards the first surface S300a of the covering device. The laser 2 may be configured to write a plurality of optical lenses 312, as shown in FIG. 5, behind each other in the material of the covering device 300. The laser 2 may also be used to write only one lens 312 into the material of the covering device 300.

According to a further embodiment of the method to manufacture the optical coupler 1 shown in FIG. 8, light is launched into the optical fiber 100 at an end E100b of the optical fiber. The light is coupled out of the optical fiber 100 by means of total internal reflection or a reflective coating at the end face E100a and, after going through the light-guiding structure/waveguide 311 or the at least one optical lens 312 in the material of the covering device 300, the light is coupled out at the second surface S300b of the covering device.

A spot of the light coupled out of the covering device 300 is evaluated. For this purpose a dichroic mirror 3 and a real-time spot size monitoring device 4 are provided. The light coupled out at the second surface S300b of the covering device/lid 300 is deflected by means of the mirror 3 towards the real-time spot size monitoring device 4. The process of preparing the light-guiding structure/waveguide 311 or the at least one lens 312, is changed or modified in dependence on the evaluation of the spot of the light monitored by means of the real-time spot size monitoring device 4. The laser to write the light-guiding structure/waveguide 311 or the at least one optical lens 312 may be configured as a femtosecond laser.

According to the method to manufacture the optical coupler 1 illustrated in FIG. 8, the first area 310 is written inside the material of the covering device 300 and/or the cladding of the at least one optical fiber by means of femtosecond laser-processing of the completely assembled and machined optical coupler comprising the supporting device 200, the at least one optical fiber 100 and the covering device 300. According to the method, real-time in situ precise femtosecond laser beam positioning and optimization of parameters of a waveguide/optical lens may be reached by coupling light with wavelength coincident with coupler designed operation wavelength, for example light of a wavelength of 1310/1490/1550 nm radiation at the end E100b in the at least one optical fiber 100 and output the light for spot size monitoring. The propagation loss of a femtosecond laser induced waveguide can be as low as about 0.2 dB per cm. Thus, propagation loss is negligible for a typical thickness of 1 mm for the covering device/lid 300.

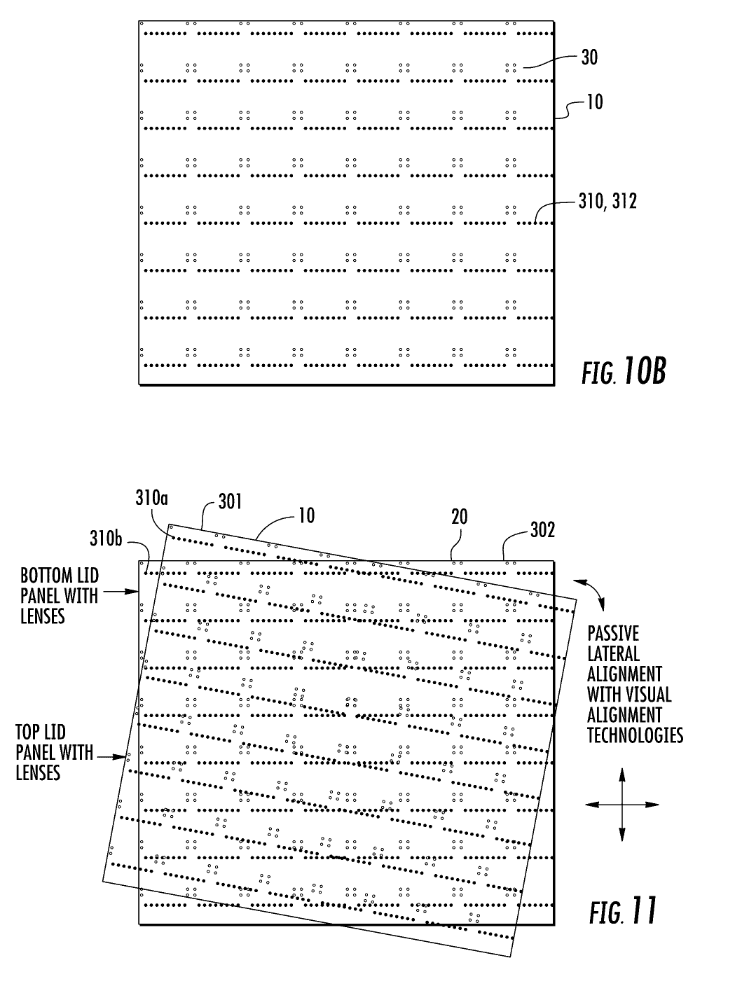

FIG. 9 shows an ion exchange process as part of another embodiment of a method to manufacture an optical coupler 1 to couple light in/out of an optical receiving/emitting structure which enables to manufacture an optical coupler with a covering device 300 having a first area 310 configured as at least one optical lens 312, for example as a GRIN lens, as shown in FIGS. 6A and 6B. The covering device 300 having the first surface S300a and the opposite second surface S300b is provided, wherein the covering device 300 is made of an optically transparent material and still does not comprises the first and the second area 310, 320 of different index of refraction.

The covering device 300 is prepared by means of an ion exchange process such that the covering device 300 is provided with the first area 310 and the second area 320 surrounding the first area 310, wherein the first area 310 and the second area 320 are provided with a respective different index of refraction or a change of the respective index of refraction so that the first area 310 is configured as an optical lens being embedded in the second area 320 and forming an optical pathway in the covering device. As discussed herein, the manufacturing process may be provide gradual changes in refractive indexes so there may not be sharp boundary between the first and second areas 310, 320.

As shown in FIG. 9, to perform the ion exchange process, a metallic mask 40 may be applied to a surface of the covering device 300 with lithography processes. Openings 41 may be formed in the mask 40 at positions where the optical lenses 312 need to be located. The masked substrate of the covering device/lid may be processed in a molten bath of silver nitride. The silver ions start to diffuse into the glass material of the covering device 300 and depending on the shape of the mask, lenses with a gradient refractive index profile can be created in the material of the covering device 300.

An advantage of the ion exchange process is that the surface of the covering device 300 stays planar. The ion exchange process may be used for providing a lot of optical lenses 312 next to each other in the material of the covering device 300 as shown in FIG. 10A. The ion exchange process is suited to parallelize the production of the lenses. A stereolithographic or laser based process may be used to define the location of the lenses on a whole panel. Therefore, stacking of multiple covering device parts may be done on the panel level while achieving a relatively-high lens-pitch accuracy of 100 nm or less.

While, when writing optical lenses with a femtosecond laser, the lenses can be located at an arbitrary position (depth) in the material of the covering device, the optical lenses created by the ion exchange process can be formed on the surface of a substrate of the covering device only. Thus, a separation of the covering device 300 in the two portions 301 and 302, as shown in FIGS. 6A and 6B, is necessary to introduce a lens on the inner surface of the parts 301, 302 or other suitable part.

The ion exchange process may take place on panel level where multiple single covering devices 300 may be formed at the same time. The metallic mask 40 may be removed after the ion exchange process. Residuals of the mask can be kept on each of the covering devices to form alignment marks/fiducials 30 for a passive alignment processes later on. The manufacturing is scalable to larger substrates. FIG. 10B shows a panel 10 with a plurality of processed covering devices 300 comprising optical lenses 312 and alignment marks 30. The panel 10 may be separated into individual sub-assemblies of covering devices 300 by laser cutting or dicing technologies.

After a panel 10 comprising the respective first portion 301 of the covering devices 300 is produced, it can be stacked with a second panel 20 comprising the respective second portion 302 of the covering devices. The second panel 20 may be configured as another lens substrate, to provide an embodiment as shown in FIG. 6B, or bare glass substrate to provide the embodiment as shown in FIG. 6A. With the help of the aforementioned fiducials 30 on the panels 10, 20 and because of its large dimensions very accurate passive alignment between two lens layers can be achieved leading to low penalties in the optical performance.

FIG. 11 shows the alignment of the panel 10 comprising the first portion 301 of the covering devices and the panel 20 comprising the second portions 302 of the covering devices. Passive lateral alignment with visual alignment technologies is possible. After aligning and attaching the two panels shown in FIG. 11, the individual covering devices 300 respectively comprising one of the first and second portions 301, 302 may be singularized by dicing or laser cutting processes.

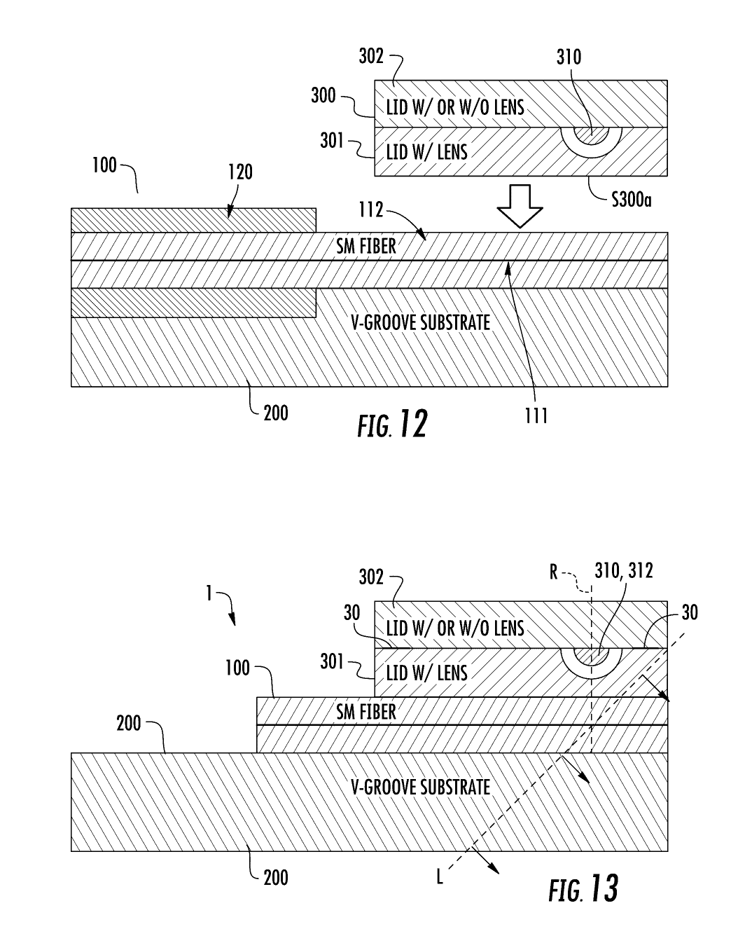

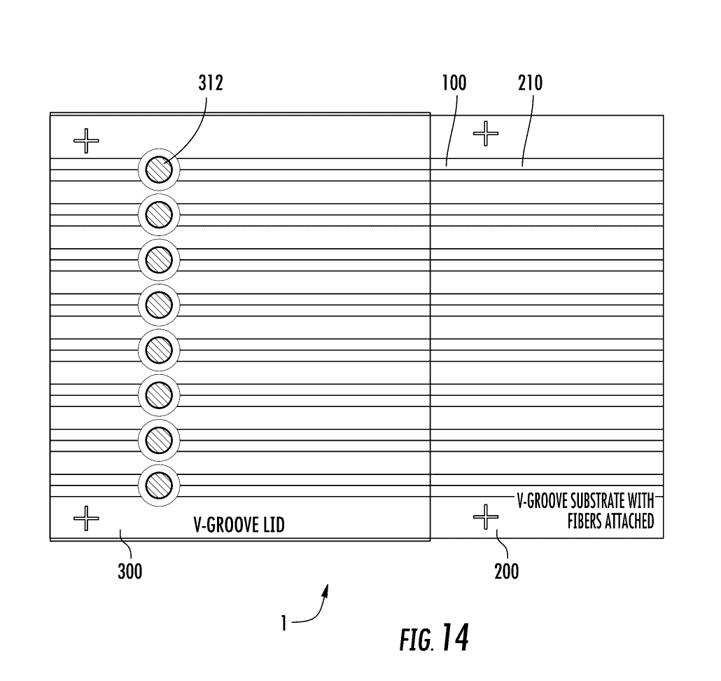

As shown in FIG. 12, a covering device 300 may get picked and placed to a substrate comprising the supporting device 200 with the at least one optical fiber 100 arranged in the supporting structure 210. Visual alignment between an optical lens 312 in the material of the covering device 300 and the at least one optical fiber 100 can be performed using the alignment marks and the features of the supporting structure 210, for example, the v-grooves.

After the attachment of the covering device 300 to the supporting device 200 with the at least one optical fiber 100 inserted in the supporting structure 210, the mirror at the fiber end face E110a needs to be processed. FIG. 13 shows by the dashed line L the cleaving position with respect to the optical lenses. The alignment marks 30 in the material of the covering device 300 may be seen from the side so that they can be used to localize the cleaving position. The dashed line R in FIG. 13 shows the correct position along the fiber axis of the cleave with respect to the optical fiber core.

FIG. 14 shows a top view of the manufactured optical coupler 1 with supporting structures 210 configured as v-grooves in the supporting device 200. The covering device/lid 300 is attached on the supporting device 200 to fix the optical fibers 100 in the v-grooves.

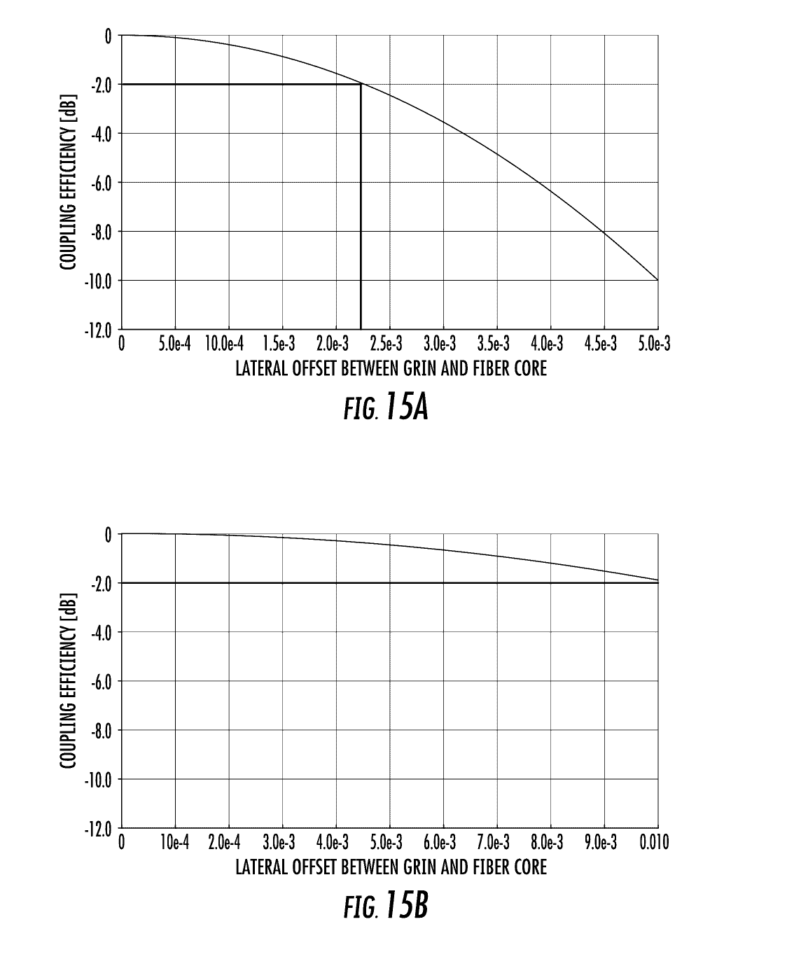

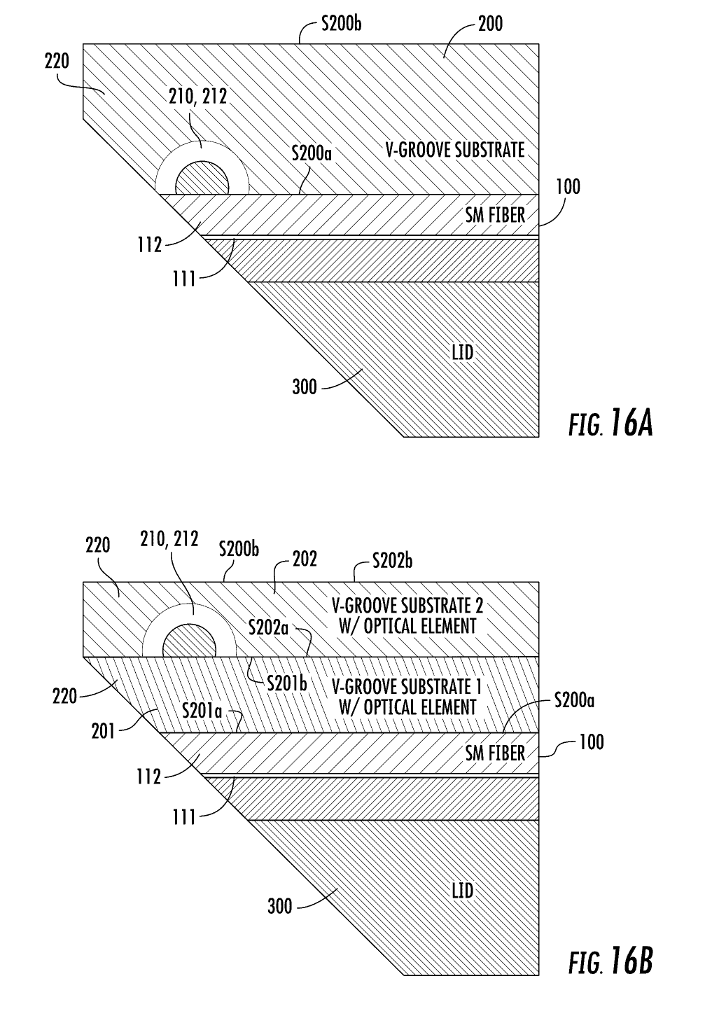

FIGS. 15A and 15B show diagrams illustrating coupling efficiency versus displacement tolerances without and with compensation respectively of inaccurate mirror position. The diagrams show the influence of a misalignment of an optical lens structure in the covering device with reference to a fiber core/cleave position.

In particular, the diagram shown in FIG. 15A illustrates the impact of a displacement of the optical lens structure with reference to the optical core of an optical fiber for up to 5 μm. However, the cleave position inaccuracy can be compensated by moving the optical coupler with respect to the optical receiving/emitting structure on the PIC. The diagram shown in FIG. 15B was produced by compensating the misalignment by changing the position of the optical receiving/emitting structure by the same amount as the lens-to-cleave misplacement. As illustrated by FIG. 15B, the 2 dB loss displacement was pushed out from 2.2 μm to more than 10 μm. The loss is now mainly created by aberrations of the lens, because the light beam does not propagate perpendicularly through the lens profile.

FIGS. 4A to 7 describe an embodiment of an optical coupler, wherein an optical waveguide 311 is provided in the cladding 112 of at least one optical fiber 110 and in the covering device 300 as well as embodiments of the optical coupler, wherein at least one optical lens 312 is provided in the covering device 300. The supporting device and covering device are interchangeable with one or both the supporting device and covering device having an alignment structure such as a groove for positioning the at least one optical fiber. Moreover, the optical pathway may be formed in either the supporting device or the covering device as desired depending on the direction of the turning/reflective surface (e.g., up or down) on the end of the at least one optical fiber. Further, the optical pathway may change the effective pathway area for optical matching.

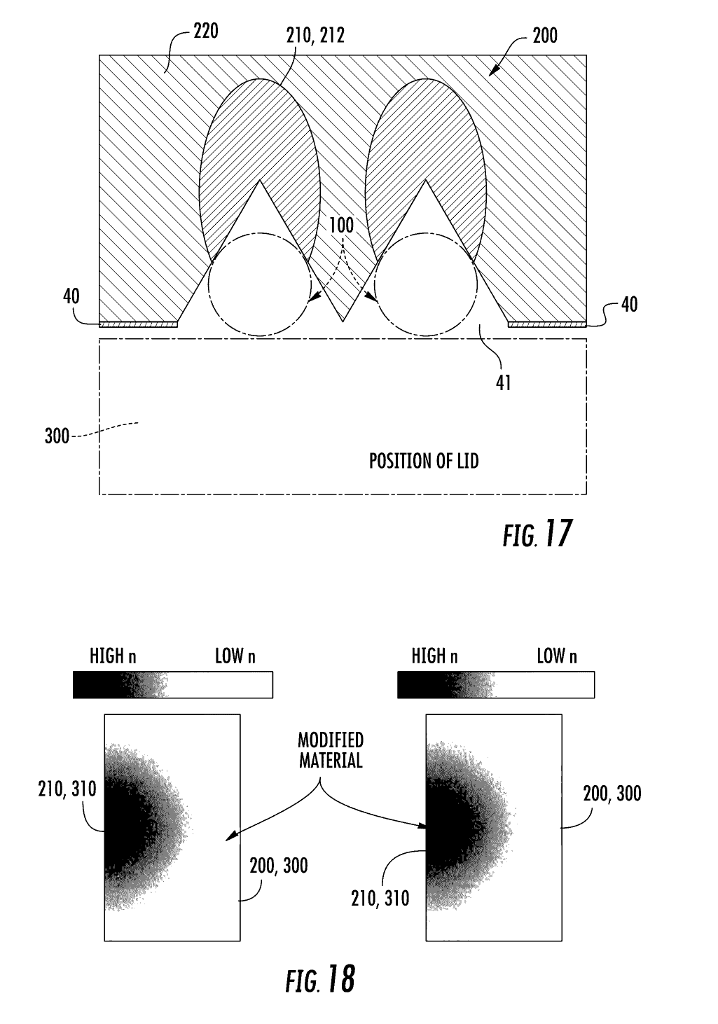

According to an embodiment of the optical coupler shown in FIGS. 16A and 16B, the optical elements, i.e. the waveguide or the at least one optical lens may be provided in the supporting device 200 instead of the covering device 300, if the end face of the at least one optical fiber 100 is configured to reflect the light from the core 111 of the at least one optical fiber towards the supporting device 200. To this purpose, the direction of polish/cleave of the optical coupler may be reversed in comparison to the direction of polish/cleave of the optical coupler illustrated in FIGS. 4A to 6B. The optical waveguide may be provided in the material of the supporting device 200 and the cladding 112 of the at least one optical fiber 100. According to another embodiment of the optical coupler, the at least one optical lens may be provided in the material of the supporting device 200.

FIG. 16A shows an embodiment of an optical coupler, wherein an optical element, for example an optical lens 212, is provided in the material of the supporting device 200. The supporting device 200 may be configured as a V-groove substrate consisting of only one part. The optical lens 212 is provided in the first surface S200a of the supporting device 200. FIG. 16B shows another embodiment of an optical coupler, wherein the supporting device 200 comprises a first and a second portion 201, 202. An optical lens 212 is included in the second portion 202 of the supporting device 200.

According to the embodiment of the optical coupler shown in FIGS. 16A and 16B, the direction of the cleave that is provided in the supporting device 200 and the covering device 300 is inverted in comparison to the embodiment of the optical coupler shown in FIGS. 4A and 5 to reflect the light from the optical fiber 100 towards the supporting device 200. The end face E100a of the at least one optical fiber 100 comprises a light-turning/reflective surface being configured to reflect light such that the light guided in the at least one optical fiber 100 is reflected at the end face E100a of the at least one optical fiber 100 to be coupled out of the at least one optical fiber and coupled in the supporting device 200 at a first surface S200a of the supporting device 200 and to propagate through an optical pathway of the supporting device 200 and coupled out of the optical coupler at a second surface S200b of the supporting device 200 to be coupled into the optical receiving structure. The light-turning/reflective surface may be configured such that the light coupled into the optical coupler from the optical emitting structure at the second surface S200b of the supporting device 200 propagates through the optical pathway of the supporting device 200 and is coupled out of the first surface S200a of the supporting device into the at least one optical fiber 100 at the end face E100a of the at least one optical fiber.

The supporting device 200 comprises a first area 210 and a second area 220 surrounding the first area 210, wherein the first area 210 and the second area 220 are provided with a respective different index of refraction or a change of the respective index of refraction so that the first area is configured as one of an optical waveguide and an optical lens being embedded in the second area of the supporting device and forming the optical pathway in the supporting device 200.

The first area 210 and the second area 220 of the supporting device 200 may have a different index of refraction. According to another embodiment of the optical coupler, the second area 220 of the supporting device 200 is provided with a second index of refraction. The first area 210 of the supporting device 200 is provided with a transition/change of the index of refraction from a first index of refraction to the second index of refraction.

When the first area 210 of the supporting device 200 is formed as a waveguide, the waveguide is configured as the optical pathway to transfer the light inside the supporting device 200. The waveguide is arranged between the fiber core 111 of the at least one optical fiber 100 and the second surface S200b of the supporting device 200.

As shown in FIG. 16A and FIG. 16B, the first area 210 of the supporting device 200 may be configured as the at least one optical lens being configured to receive the light rays of the light coupled in the supporting device 200 at the first surface S200a of the supporting device 200 and to focus the light rays in the direction towards the second surface S200b of the supporting device 200 and/or to receive the light rays of the light coupled in the supporting device 200 at the second surface S200b of the supporting device 200 and to focus the light rays in the direction towards the first surface S200a of the supporting device 200.

According to the embodiment of the optical coupler illustrated in FIG. 16B, the supporting device 200 may comprises a first portion 201 and a second portion 202. The first portion 201 of the supporting device 200 has a first side S201a comprising the first surface S200a of the supporting device 200 and a second side S201b. The second portion 202 of the supporting device 200 has a first side S202a and a second side S202b comprising the second surface S200b of the supporting device. The first portion 201 of the supporting device is attached with the first side S201a to the covering device 300 and is attached with the second side S201b to the first side S202a of the second portion 202 of the supporting device 200. The first area 210 of the supporting device 200 may extend from the first side S202a of the second portion 202 of the supporting device into the material of the second portion 202 of the supporting device.

According to another embodiment of the optical coupler, the first area 210 of the supporting device 200 may comprises a first and a second section. The first section of the first area 210 of the supporting device may extend from the second side S201b of the first portion 201 of the supporting device into the material of the first portion of the supporting device. The second section of the first area 210 of the supporting device may extend from the first side S202a of the second portion 202 of the supporting device into the material of the second portion of the supporting device.

The at least one optical element can be formed within the material of the supporting device by a laser writing process in a similar way as described for the implementation of the optical waveguide and/or the at least one optical lens in the covering device according to FIG. 8. Another possibility to provide the at least one optical element within the material of the supporting device is to use a ion exchange process in a similar manner as described for the implementation of the at least one optical lens in the covering device according to FIGS. 9 to 11.

The supporting device 200 may be prepared by means of an ion exchange process such that the supporting device 200 is provided with the first area 210 and the second area 220 surrounding the first area 210, wherein the first area 210 and the second area 220 are provided with a respective different index of refraction or a change of the respective index of refraction so that the first area 210 is configured as an optical lens being embedded in the second area 220 and forming an optical pathway in the supporting device. The manufacturing process may provide gradual changes in refractive indexes so there may not be sharp boundary between the first and second areas 310, 320.

As shown in FIG. 17, to perform the ion exchange process, a metallic mask 40 may be applied to a surface of the supporting device 200 with lithography processes. Openings 41 may be formed in the mask 40 at positions where the optical lenses 212 need to be located. The masked substrate of the supporting device may be processed in a molten bath of silver nitride. The silver ions start to diffuse into the material of the supporting device/substrate 200 and depending on the shape of the mask, lenses with a gradient refractive index profile can be created in the material of the supporting device 200. After having provided the supporting device 200 with the optical elements, the optical fibers may be arranged in the supporting structure/grooves of the supporting device and the covering device 300 may be attached on the first surface S200a of the supporting device 200 to fix the optical fibers in the supporting structure.

FIG. 18 illustrates on the left-hand side a first possibility to implement the at least one optical lens in the material of the covering device 300 or the supporting device 200 by means of a ion exchange process. The material of the first area 210/310 of the supporting device 200 or the covering device 300 may be modified by the ion exchange process to provide the first area 210/310 with the higher index of refraction and the second area 220/320 with the lower index of refraction or to provide the first area 210/310 with the change of the index of refraction from the value of the first index of refraction to the value of the second index of refraction.

According to another embodiment of the manufacturing process illustrated in FIG. 18 on the right-hand side, it is possible to use a ion exchange process by which the material of the second area 220/320 of the supporting device 200 or the covering device 300 is modified such that the first area 210/310 is provided with the higher index of refraction and the second area 220/320 is provided with the lower index of refraction or the first area 210/310 is provided with the change of the index of refraction from the value of the first index of refraction to the value of the second index of refraction.

We claim:

1. An optical coupler for coupling light in/out of an optical receiving/emitting structure, comprising:
at least one optical fiber,
a supporting device to support the at least one optical fiber comprising a supporting structure in which the at least one optical fiber is arranged,
a covering device to cover the supporting structure, wherein the covering device has a first surface and a second surface that is on an opposite side of the first surface,
wherein an end face of the at least one optical fiber comprises a reflective surface being configured to reflect light such that the light guided in the at least one optical fiber is reflected at the end face of the at least one optical fiber to be coupled out of the at least one optical fiber and coupled in one of the covering device and the supporting device at the first surface of said one of the covering device and the supporting device and propagate through an optical pathway of said one of the covering device and the supporting device and coupled out of the optical coupler at the second surface of said one of the covering device and the supporting device to be coupled into the optical receiving structure and/or the light coupled into the optical coupler from the optical emitting structure at the second surface of said one of the covering device and the supporting device propagates through the optical pathway of said one of the covering device and the supporting device and is coupled out of the first surface of said one of the covering device and the supporting device into the at least one optical fiber at the end face of the at least one optical fiber,
wherein one of the covering device and the supporting device comprises a first area and a second area surrounding the first area, wherein the first area and the second area are provided with a respective different index of refraction or a change of the respective different index of refraction so that the first area is configured as one of an optical waveguide and an optical lens being embedded in the second area and forming the optical pathway in said one of the supporting device and the covering device.

2. The optical coupler of claim 1,
wherein the first area of said one of the covering device and the supporting device is provided with a transition of the index of refraction from a first index of refraction to a second index of refraction,
wherein the second area of said one of the covering device and the supporting device is provided with a second index of refraction.

3. The optical coupler of claim 1,
wherein, when the first area of said one of the covering device and the supporting device is formed as a waveguide, the waveguide is configured as the optical pathway to transfer the light inside said one of the covering device and the supporting device,
wherein the waveguide is arranged between the fiber core of the at least one optical fiber and the second surface of said one of the covering device and the supporting device.

4. The optical coupler of claim 1,
wherein the first area of said one of the covering device and the supporting device is configured as at least one optical lens being configured to receive the light rays of the light coupled in said one of the covering device and the supporting device at the first surface of said one of the covering device and the supporting device and to focus the light rays in the direction towards the second surface of said one of the covering device and the supporting device and/or to receive the light rays of the light coupled in said one of the covering device and the supporting device at the second surface of said one of the covering device and the supporting device and to focus the light rays in the direction towards the first surface of said one of the covering device and the supporting device.

5. The optical coupler of claim 1,
wherein the covering device comprises a first and a second portion,
wherein the first portion of the covering device has a first side comprising the first surface of the covering device and a second side,
wherein the second portion of the covering device has a first side and a second side comprising the second surface of the covering device,
wherein the first portion of the covering device is attached with the first side to the supporting structure of the supporting device and is attached with the second side to the first side of the second portion of the covering device.

6. The optical coupler of claim 5,
wherein the first area of the covering device extends from the second side of the first portion of the covering device into the material of the first portion of the covering device.

7. The optical coupler of claim 5,
wherein the first area of the covering device comprises a first and a second section,
wherein the first section of the first area of the covering device extends from the second side of the first portion of the covering device into the material of the first portion of the covering device,
wherein the second section of the first area of the covering device extends from the first side of the second portion of the covering device into the material of the second portion of the covering device.

8. The optical coupler of claim 1,
wherein the supporting device comprises a first and a second portion,
wherein the first portion of the supporting device has a first side comprising the first surface of the supporting device and a second side,
wherein the second portion of the supporting device has a first side and a second side comprising the second surface of the supporting device,
wherein the first portion of the supporting device is attached with the first side to the covering device and is attached with the second side to the first side of the second portion of the supporting device.

9. The optical coupler of claim 8,
wherein the first area of the supporting device extends from the first side of the second portion of the supporting device into the material of the second portion of the supporting device.

10. The optical coupler of claim 8,
wherein the first area of the supporting device comprises a first and a second section,
wherein the first section of the first area of the supporting device extends from the second side of the first portion of the supporting device into the material of the first portion of the supporting device,
wherein the second section of the first area of the supporting device extends from the first side of the second portion of the supporting device into the material of the second portion of the supporting device.

11. The optical coupler of claim 1,
wherein the first area of said one of the covering device and the supporting device is configured as a GRIN lens.

12. The optical coupler of claim 5,
wherein the first portion of the covering device comprises a cavity in the second side of the first portion of the covering device, wherein the cavity is filled with an adhesive having an index of refraction being different from the index of refraction of the material of the first portion of the covering device.

13. The optical coupler of claim 5,
wherein the second portion of the covering device comprises a cavity in the first side of the second portion of the covering device, wherein the cavity is filled with an adhesive having an index of refraction being different from the index of refraction of the material of the second portion of the covering device.

14. The optical coupler of claim 1,
wherein the at least one optical fiber is arranged in the supporting structure such that the end face of the at least one optical fiber ends in a plane of a lateral surface of the optical coupler,
wherein the lateral surface of the optical coupler is cut such that the plane of the lateral surface is inclined in relation to a longitudinal direction of the portion of the at least one optical fiber arranged in the supporting structure by an angle being larger than the angle at which total internal reflection of the light guided in the at least one optical fiber occurs at the end face of the at least one optical fiber.

15. The optical coupler of claim 1,
wherein the at least one optical fiber is arranged in the supporting structure such that the end face of the at least one optical fiber ends in a plane of a lateral surface of the optical coupler,
wherein the lateral surface of the optical coupler is cut such that the plane of the lateral surface is inclined in relation to a longitudinal direction of the portion of the at least one optical fiber arranged in the supporting structure,
wherein the end face of the at least one optical fiber is metalized, provided with a reflective single or multi-layer dielectric coating or a diffractive element attached to it to reflect the light.

16. The optical coupler of claim 1,
wherein the supporting structure comprises at least one groove to support the at least one optical fiber, wherein the at least one groove is configured as a v-groove or a U-groove or a square-groove.

17. A method to manufacture an optical coupler for coupling light in/out of an optical receiving/emitting structure, comprising:
providing a supporting device comprising a supporting structure,
providing a covering device having a first surface and an opposite second surface,
arranging at least one optical fiber in the supporting structure,
placing a covering device on the supporting structure such that the supporting structure is covered by the first surface of the covering device and the at least one optical fiber is fixed between the supporting structure and the covering device,
preparing an end face of the at least one optical fiber such that the light guided in the at least one optical fiber is reflected at the end face of the at least one optical fiber to be coupled out of the at least one optical fiber and coupled in one of the covering device and the supporting device at the first surface of said one of the covering device and the supporting device and to propagate through an optical pathway of said one of the covering device and the supporting device and coupled out of the optical coupler at the second surface of said one of the covering device and the supporting device to be coupled into the optical receiving structure and/or the light coupled into the optical coupler from the optical emitting structure at the second surface of said one of the covering device and the supporting device propagates through the optical pathway of said one the covering device and the supporting device and is coupled out of the first surface of said one of the covering device and the supporting device into the at least one optical fiber at the end face of the at least one optical fiber,
preparing said one of the covering device and the supporting device by means of a laser such that said one of the covering device and the supporting device is provided with a first and a second area surrounding the first area, wherein the first area and the second area are provided with a respective different index of refraction or a change of the respective index of refraction so that the first area is configured as one of an optical waveguide and an optical lens being embedded in the second area and forming the optical pathway in said one of the supporting device and the covering device.

18. The method of claim 17,
wherein said one of the covering device and the supporting device is prepared by the laser such that the second area of said one of the covering device and the supporting device is provided with a second index of refraction,
wherein the first area of said one of the covering device and the supporting device is provided with a transition of the index of refraction from a first index of refraction to the second index of refraction.

19. The method of claim 17, comprising:
writing a waveguide to transfer the light inside the optical pathway of said one of the covering device and the supporting device by means of the laser between the fiber core of the at least one optical fiber and the second surface of said one of the covering device and the supporting device.

20. The method of claim 17, comprising:
writing the first area of said one of the covering device and the supporting device by means of the laser to provide at least one optical lens inside said one of the covering device and the supporting device, wherein the at least one optical lens is configured to receive the light rays of the light coupled in said one of the covering device and the supporting device at the first surface of said one of the covering device and the supporting device and to focus the light rays in the direction towards the second surface of said one of the covering device and the supporting device and/or to receive the light rays of the light coupled in said one of the covering device and the supporting device at the second surface of said one of the covering device and the supporting device and to focus the light rays in the direction towards the first surface of said one of the covering device and the supporting device.

21. The method of claim 17, comprising:
coupling light into the at least one optical fiber,
coupling out the light at the second surface of said one of the covering device and the supporting device,
evaluating a spot of the light coupled out of said one of the covering device and the supporting device,
changing the process of preparing the first area inside said one of the covering device and the supporting device in dependence on the evaluation of the spot of the light coupled out of said one of the covering device and the supporting device.

22. The method of claim 17,
wherein the laser is configured as a femtosecond laser.

23. A method to manufacture an optical coupler for coupling light in/out of an optical receiving/emitting structure, comprising:
providing a supporting device comprising a supporting structure,
providing a covering device having a first surface and an opposite second surface,
preparing one of the covering device and the supporting device by means of a ion exchange process such that said one of the covering device and the supporting device is provided with a first and a second area surrounding the first area, wherein the first area and the second area are provided with a respective different index of refraction or a change of the respective index of refraction so that the first area is configured as one of an optical lens being embedded in the second area and forming an optical pathway in said one of the covering device and the supporting device,
arranging at least one optical fiber in the supporting structure,
placing the covering device on the supporting structure such that the supporting structure is covered by the first surface of the covering device and the at least one optical fiber is fixed between the supporting structure and the covering device,
preparing an end face of the at least one optical fiber such that the light guided in the at least one optical fiber is reflected from the end face of the at least one optical fiber to be coupled out of the at least one optical fiber and coupled in said one of the covering device and the supporting device at the first surface of said one of the covering device and the supporting device and to propagate through the optical pathway of said one the covering device and the supporting device and coupled out of the optical coupler at the second surface of said one of the covering device and the supporting device to be coupled into the optical receiving structure and/or the light coupled into the optical coupler from the optical emitting structure at the second surface of said one of the covering device and the supporting device propagates through the optical pathway of said one of the covering device and the supporting device and is coupled out of the first surface of said one of the covering device and the supporting device into the at least one optical fiber at the end face of the at least one optical fiber.

24. The method of claim 23,
wherein the first area of said one of the covering device and the supporting device is provided with a transition of the index of refraction from a first index of refraction to a second index of refraction,
wherein the covering device is prepared by the ion exchange process such that the second area of said one of the covering device and the supporting device is provided with a second index of refraction.

25. The method of claim 23, comprising:
preparing said one of the covering device and the supporting device by means of the ion exchange process such that the first area of said one of the covering device and the supporting device is configured as the at least one optical lens being configured to receive the light rays of the light coupled in said one of the covering device and the supporting device at the first surface of said one of the covering device and the supporting device and to focus the light rays in the direction towards the second surface of said one of the covering device and the supporting device and/or to receive the light rays of the light coupled in said one of the covering device and the supporting device at the second surface of said one of the covering device and the supporting device and to focus the light rays in the direction towards the first surface of said one of the covering device and the supporting device.

26. The method of claim 23, comprising:
providing the covering device with a first and a second portion,
wherein the first portion of the covering device has a first side comprising the first surface of the covering device and a second side,
wherein the second portion of the covering device has a first side and a second side comprising the second surface of the covering device,
preparing the first portion of the covering device by means of the ion exchange process such that the first area of the covering device extends from the second side of the first portion of the covering device into the material of the first portion of the covering device,
attaching the second side of the first portion of the covering device to the first side of the second portion of the covering device,
attaching the first side of the first portion of the covering device to the supporting structure of the supporting device to fix the at least one optical fiber in the supporting structure.

27. The method of claim 23, comprising:
preparing the first area of the covering device to have a first and a second section,
preparing the first portion of the covering device by means of the ion exchange process such that the first section of the first area of the covering device extends from the second side of the first portion of the covering device into the material of the first portion of the covering device,
preparing the second portion of the covering device by means of the ion exchange process such that the second section of the first area of the covering device extends from the first side of the second portion of the covering device into the material of the second portion of the covering device,
attaching the second side of the first portion of the covering device to the first side of the second portion of the covering device,
attaching the first side of the first portion of the covering device to the supporting structure of the supporting device to fix the at least one optical fiber in the supporting structure.

28. The method of claim 23, comprising:
providing the supporting device with a first and a second portion,
wherein the first portion of the supporting device has a first side comprising the first surface of the supporting device and a second side,
wherein the second portion of the supporting device has a first side and a second side comprising the second surface of the supporting device,
preparing the second portion of the supporting device by means of the ion exchange process such that the first area of the supporting device extends from the first side of the second portion of the supporting device into the material of the second portion of the supporting device,
attaching the second side of the first portion of the supporting device to the first side of the second portion of the supporting device,
attaching the first side of the first portion of the supporting device to the covering device to fix the at least one optical fiber in the supporting structure.

29. The method of claim 23, comprising:
preparing the first area of the supporting device to have a first and a second section,
preparing the first portion of the supporting device by means of the ion exchange process such that the first section of the first area of the supporting device extends from the second side of the first portion of the supporting device into the material of the first portion of the supporting device,
preparing the second portion of the supporting device by means of the ion exchange process such that the second section of the first area of the supporting device extends from the first side of the second portion of the supporting device into the material of the second portion of the supporting device,
attaching the second side of the first portion of the supporting device to the first side of the second portion of the supporting device,
attaching the first side of the first portion of the supporting device to the covering device to fix the at least one optical fiber in the supporting structure.

30. The method of claim 23,
wherein the ion exchange process is configured as a silver ion exchange process.
